(19) United States
(12) Patent Application Publication
(10) Pub. No.: US 2014/0182441 A1
(43) Pub. Date: Jul. 3, 2014

(54) CUTTER DIES

(71) Applicants: Philip J Pisczak, Chagrin Falls, OH (US); Raymond Disantis, Willoughby Hills, OH (US); Joseph A. Maline, Cleveland, OH (US)

(72) Inventors: Philip J Pisczak, Chagrin Falls, OH (US); Raymond Disantis, Willoughby Hills, OH (US); Joseph A. Maline, Cleveland, OH (US)

(21) Appl. No.: 14/032,757

(22) Filed: Sep. 20, 2013

Related U.S. Application Data
(63) Continuation-in-part of application No. 13/849,850, filed on Mar. 25, 2013.
(60) Provisional application No. 61/614,774, filed on Mar. 23, 2012.

(51) Int. Cl. B23D 35/00

(52) U.S. Cl. CPC B23D 35/001
USPC 83/694

(57) ABSTRACT

A cutter die has an upper body and a lower body having first and second cutting blades which encapsulate a rope. A first blade holder retains the upper body and a second blade holder retains the lower body. The first blade holder has an edge for supporting the wire rope and the second blade holder has an edge for supporting the wire rope. The first cutting blade and the second cutting blade can have cutting edges which are cantered and offset. A cutter tool has a first cutting blade and first retainer; a second cutting blade and a second retainer; and a cutting jaw assembly. The first and second cutting blades and said first and second retainers are secured to first and second jaws of jaw assembly and positive stops are formed on the first and second jaws.

### CROSS REFERENCE TO RELATED APPLICATIONS

This application is a continuation-in-part of application Ser. No. 13/849,850, filed on Mar. 25, 2013 which claims priority from Provisional Patent Application Ser. No. 61/614,774, filed on Mar. 23, 2012, the entirety of which is hereby incorporated by reference.

### BACKGROUND OF THE DISCLOSURE

This disclosure relates to cutter dies. More particularly, this disclosure relates to cutter dies for use in compression or cutting or crimping tools for cutting wire ropes or cables. However, the cutter dies can be used for other applications as well.

Portable tools are used for radially crimping cylindrical workpieces such as wire ropes and cables or for cutting wire rope and cable and use crimping or cutter dies which are installed on and forced together by opposing jaws of the tool (for example, see U.S. Pat. No. 5,775,158.) Some existing cutter dies have proved unsatisfactory in cutting high tensile strength material such as wire or steel reinforced cable or steel rods. Furthermore, some existing cutting dies are unable to efficiently cut multi-strand cable, especially cable without insulation, due to the initial impact of the dies causing the multi-strand bundle to splay or yield in a spreading deformation.

Other existing cutter dies do not fully encapsulate the wire rope or prevent it from rotating while cutting. There, there exists a need for cutter dies which have tipped or canted cutting edges and channels for fully encapsulating the wire rope and preventing the rope from rotating or minimizing any rope rotation while cutting to facilitate a improved, cleaner cut.

Other benefits and aspects of the disclosure will become apparent upon a reading and understanding of the following detailed description.

### SUMMARY OF THE DISCLOSURE

The present disclosure relates to cutter dies. More particularly, it relates to a cutter dies which have tipped or canted cutting blades and channels for encapsulating wire rope and preventing or minimizing rotation of the wire rope while it is being cut.

The present disclosure relates to cutting dies for use in compression or crimping tools, and particularly relates to dies for cutting wire rope, and cable, with a portable compression or crimping tool. The cutter dies can be used with multi-strand or single strand wire rope.

In accordance with one aspect of the disclosure, a cutter die has an upper body and a lower body, the upper body has a first cutter blade and the lower body has a second cutter blade; wherein the first cutting blade and the second cutting blade encapsulate a wire rope; a first blade holder for retaining the upper body and a second blade holder retains the lower body; the first blade holder has an edge for supporting the wire rope, the second blade holder has an edge for supporting the wire rope.

In accordance with another aspect of the disclosure, a cutter die has a first body having a first cutting blade and a second body having a second cutting blade; a third body having a groove formed therein; and a fourth body having a groove formed therein; wherein the third body further has chamfered ends on opposite sides of the groove of a third body and the fourth body has chamfered ends formed on opposite sides of the groove of the fourth body, wherein the first cutting blade and the second cutting blade each has a cutting edge which is cantered and offset.

In accordance with another aspect of the present disclosure, a die is provided for use in a portable tool which crimps or cuts a workpiece between relatively moveable jaws of the tool on which the die is secured or mounted. In accordance with another aspect of the disclosure, the dies can be used with a 35 ton hydraulic tool, or 12 ton compression tool or a 6 ton battery tool.

Other aspects of the cutting dies are they include non-linear cutting blades for encapsulating and supporting the wire during cutting operations; and a separate wire channel for guiding and supporting the wire during the cutting operations.

Another aspect of the disclosure is a curved ‘shelf’ at the bottom of the wire channel to support the wire and minimize or prevent the wire rope from rotating too much during the operation thereby causing an inferior cut.

Still another aspect of the disclosure is total encapsulation of the wire rope when working in conjunction with both the non-straight cutting edge and wire channel. Another aspect of the disclosure is a removable back or wire channel plate for purposes of cleaning cutting dies including not having to remove them from the tool.

Yet another aspect of the disclosure is a cutter body with positive stops removed to facilitate debris removal and improved cutting of the tool.

Still other aspects of the disclosure will be apparent upon a reading and understanding of the following detailed description.

### BRIEF DESCRIPTION OF THE DRAWINGS

FIGS. 1 and 2 show an existing cutter die for cutting wire rope in cutting tools;

FIG. 3 shows an exploded perspective view of a cutter die in accordance with a first embodiment of the disclosure;

FIG. 4 shows a perspective view of the cutter of FIG. 3 with a wire rope therein;

FIG. 5 shows a front plan view of the cutter of FIG. 4;

FIG. 6 shows a perspective view of the cutter of FIG. 4 with a rope therein in a cutting configuration;

FIG. 7 shows a side elevational view of the cutter of FIG. 6;

FIGS. 8 and 9 show an existing cutter die with anvil-style cutting blades;

FIG. 10 shows an exploded perspective view of a cutter die in accordance with another aspect of the disclosure;

FIG. 11 is another exploded perspective view of the cutter die of FIG. 10;

FIG. 12 is a front plan view of the cutter die of FIG. 10;

FIG. 13 is an exploded view of the cutter of FIG. 10 with a wire rope therein;

FIG. 14 is a side elevational view in cross section of the cutter of FIG. 13;

FIG. 15 is a front plan view of the cutter of FIG. 13;

FIG. 16 shows a front elevational view of a cutter die in accordance with still another aspect of the disclosure;

FIG. 17 shows a front elevational view of the cutter die of FIG. 16 showing additional rotation;

FIG. 18 shows a perspective view of the cutter die of FIG. 17 ;

FIG. 19 shows a perspective view of the cutter die of FIG. 18;

FIG. 20 is a elevational view of the cutter of FIG. 19 cutting a wire rope;

FIG. 21 is a side elevational view of the die of FIG. 20;

FIG. 22 is a side elevational view of the cutter jaw of FIG. 21;

FIG. 23 is a side perspective view of the cutter jaw of FIG. 22;

FIG. 24 is a perspective exploded view of a lower cutter jaw and channel of FIG. 20; and

FIG. 25 is a side elevational view of the cutter die being used in a hand held tool.

FIG. 26 shows a perspective view of a cutter body installed in a cutter jaw in an opened configuration in accordance with another aspect of the disclosure;

FIG. 27 is a perspective view of the cutter bodies of FIG. 26;

FIG. 28 is a side elevational view of the cutter jaw and cutter body assembly of FIG. 26 in a closed configuration;

FIG. 29 is a cross-sectional view taken along lines A-A of FIG. 28;

FIG. 30 is an enlarged partial view of the cutter body and cutter jaw of FIG. 29;

FIG. 31 is a perspective view of the cutter body of FIG. 26 in an open configuration;

FIG. 32 is a perspective view of the cutter body of FIG. 31 with the retainer removed to show material removed from cutter body;

FIG. 33 is a front perspective view of the cutter body of FIG. 31 in a closed configuration; and

FIG. 34 is a cross-sectional view taken along line A-A of FIG. 33.

### DETAILED DESCRIPTION OF THE DISCLOSURE

The present disclosure relates to cutter dies. More particularly, it relates to cutter dies which have tipped or canted or angled or sloped cutting blades and channels for encapsulating wire rope and preventing or minimizing rotation of the wire rope while it is being cut.

The present disclosure relates to cutting dies for use in compression or crimping tools, and particularly relates to dies for cutting wire rope, and cable, with a portable compression or crimping tool. The cutter dies can be used with multi-strand or single strand wire rope.

In accordance with one aspect of the present disclosure, a die is provided for use in a portable tool which crimps or cuts a workpiece between relatively moveable jaws of the tool on which the die is secured or mounted. A pair of dies in accordance with the disclosure each has a cutting edge formed on a die body. The dies can be preferably used with a 35 ton hydraulic tool, or 12 ton compression tool or a 6 ton battery tool. However, the dies can be used in other applications and in other environments as well.

The die, installed preferably on a portable tool jaw, also includes retaining structure secured on the die body adjacently spaced from the cutting edge and arranged to support the workpiece engageable thereagainst to prevent deformation or splaying of a multi-stranded workpiece at a supported position during impingement and deformation by the cutting edge at a location on the workpiece.

In a preferred embodiment, the retaining structure includes a pair of spaced support walls laterally arranged on the die body relative to an intermediate position of the cutting edge. The pair of lateral support walls provide particular support to prevent spreading or splaying of multi-strand cable, and maintain the cable configuration to some extent during cutting. The support can be removably bolted or otherwise fastened to the die body between a support wall and the die body.

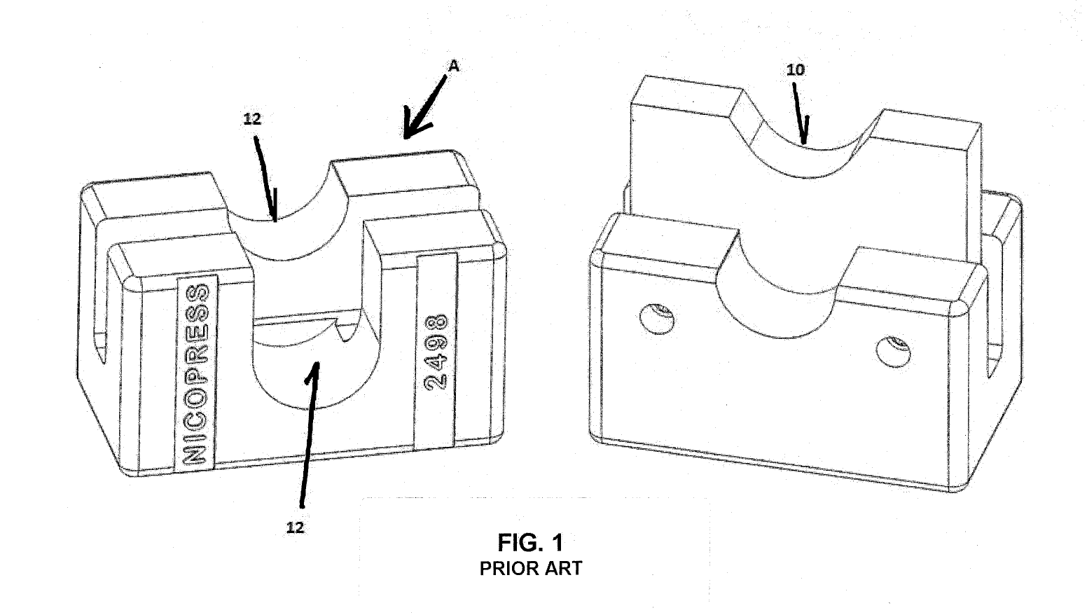

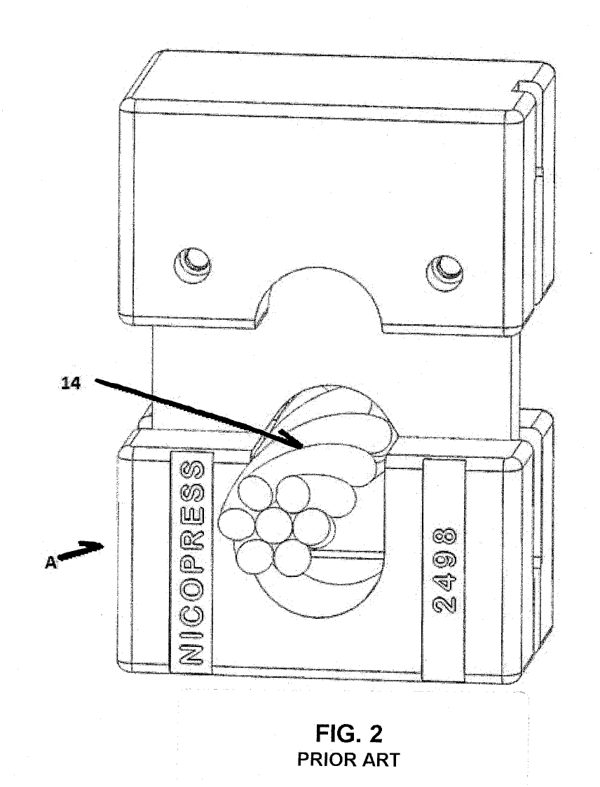

As can be seen from FIGS. 1 and 2, an existing cutter die A has a separate cutting blade 10 which does not have a flat edge and is able to keep the wire rope from sliding to one side when performing the cut. The die that holds the blade also has a channel 12 which acts as a wire cutting support shelf or guide which keeps the wire rope 14 from sliding to one side and prevents it from rotating too much when confined in the channel during cutting. A problem with this existing cutter device is it would sometimes jam with small pieces of wire rope strands being caught between the cutter and die holder.

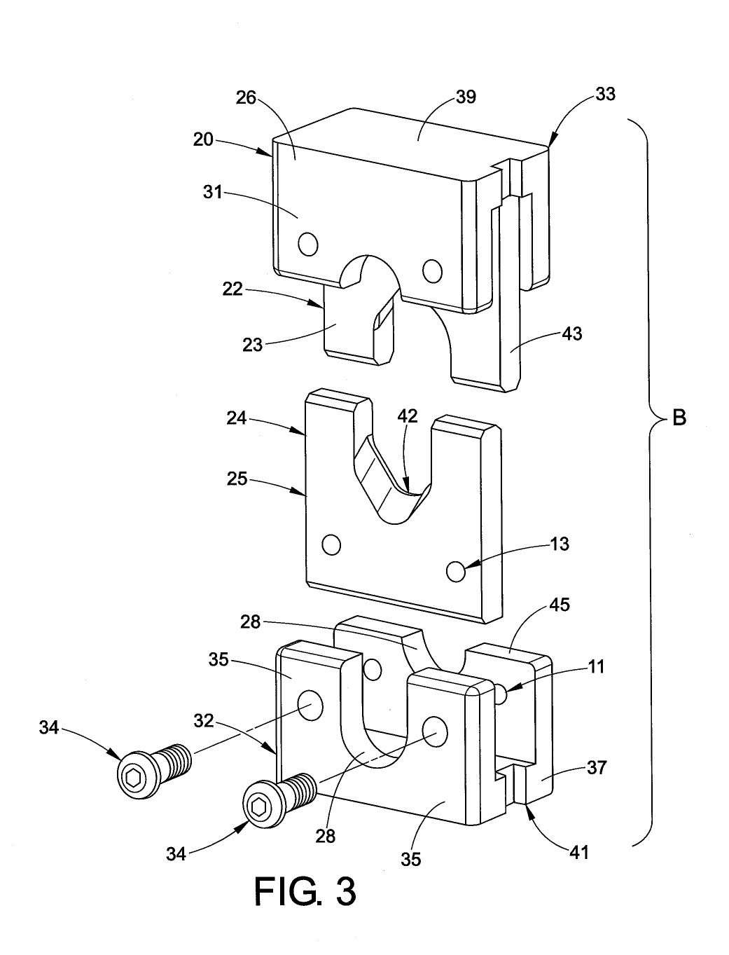

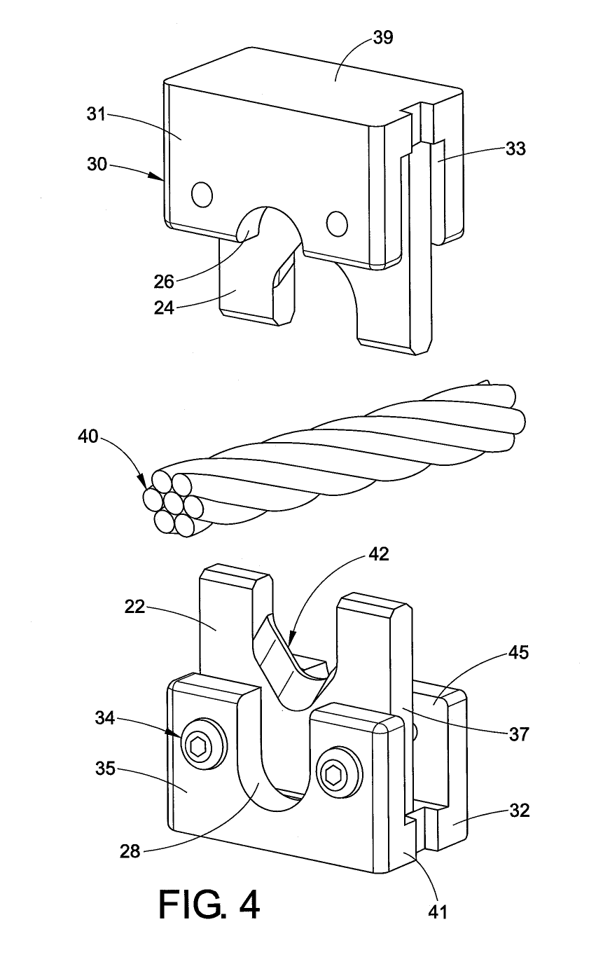

Thus, referring to FIGS. 3-7, in accordance with a first embodiment of the disclosure, a cutter die B provides better support and a finer, cleaner cut with double blades which provides tighter tolerances between the blade and holder.

Referring still to FIGS. 3-7, cutter die holder 20 has two cutter blades 22, 24 which are preferably symmetrical to each other. Blades 22, 24 are preferably formed from square or rectangular metal plates 23, 25 of varying thicknesses. Wire support shelves 26, 28 are formed on an upper die holder body 30 and a lower die holder body 32. Bodies 30, 32 are formed by side walls 31, 33, 35, 37 and upper and lower walls 39, 41 which form a recess or channel 43, 45 to receive the blades 22, 24 therein. Bolts 34 or other fasteners are used to secure the cutting blades in the holders 30, 32 via holes 11, 13.

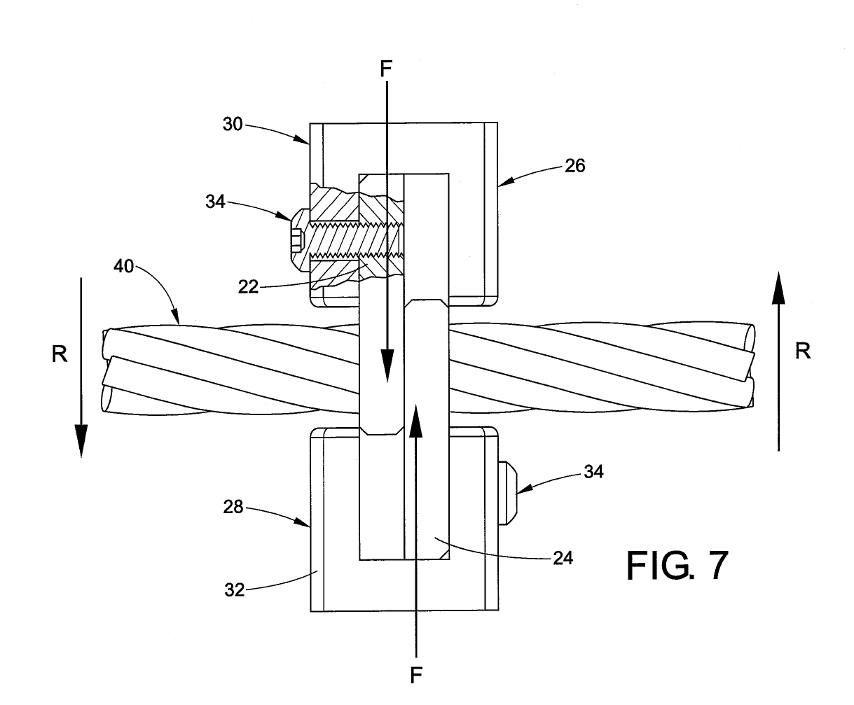

As seen in FIG. 7, the cutting shelves 26, 28 help minimize or prevent excessive rotation (R) due to the cutting force of the rope 40 as it is being cut. The shelves 26, 28 can be formed by a U-shaped or curved notch or groove in bodies 30, 32. FIG. 7 shows a cutting force F being applied to the rope 40 via the cutting blades 22, 24.

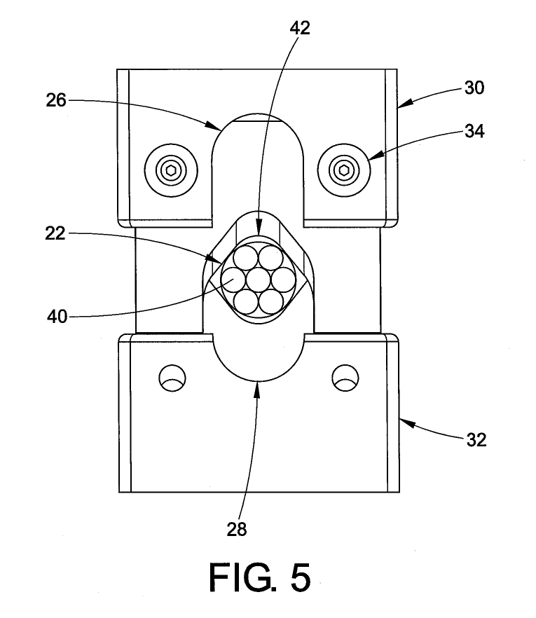

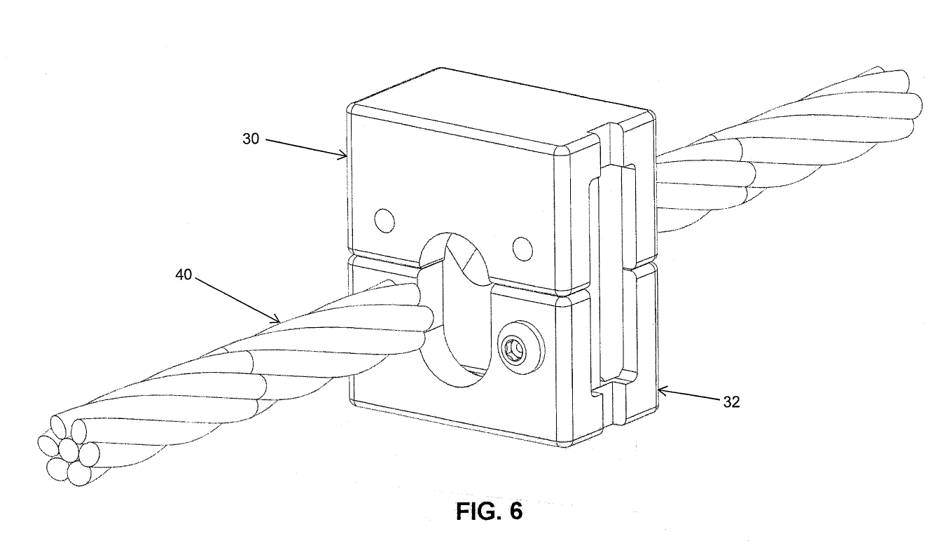

As can be seen in FIGS. 5-7, the wire rope 40 is entirely encapsulated between substantially “V”-shaped groove sections 43, 43 of the cutting blades 22, 24. The feature provides both cleaving as well as slicing action when the wire rope is cut. When the cut is complete the assembly looks as shown in FIG. 6.

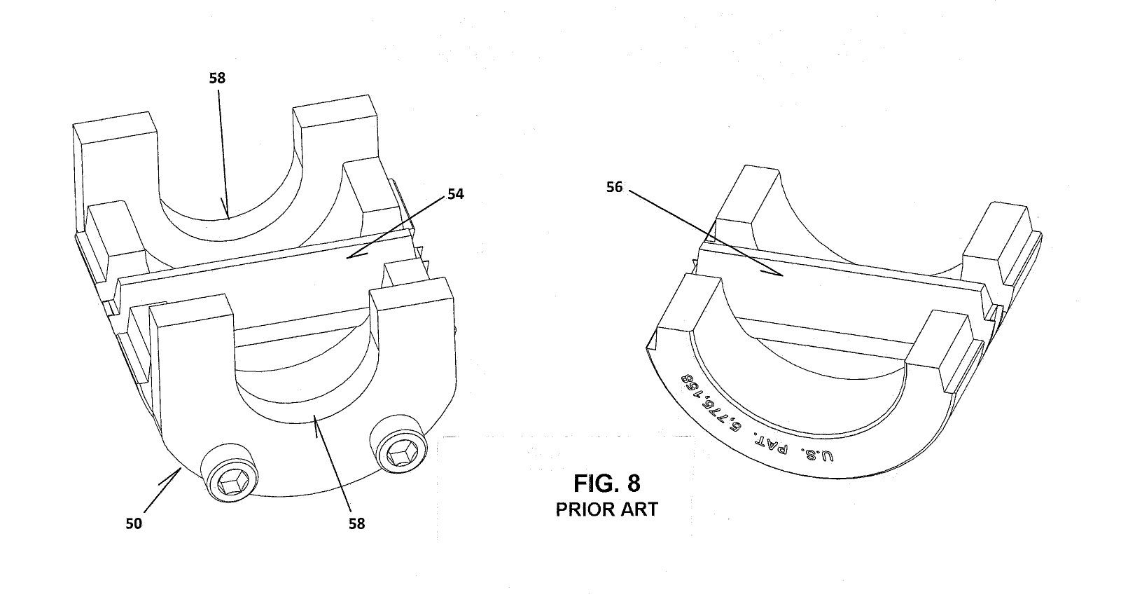

Referring now to FIGS. 8 and 9, another existing cutter die 50 is shown which does not encapsulate the wire rope 52 with each cutting blade 54, 56. Also, wire channels 58 do not serve as an anti-rotation device as in the present disclosure. Rather, the cutting blades appear as “anvils” or “anvil”-shaped which do not crossover or overlap each other as in the present disclosure.

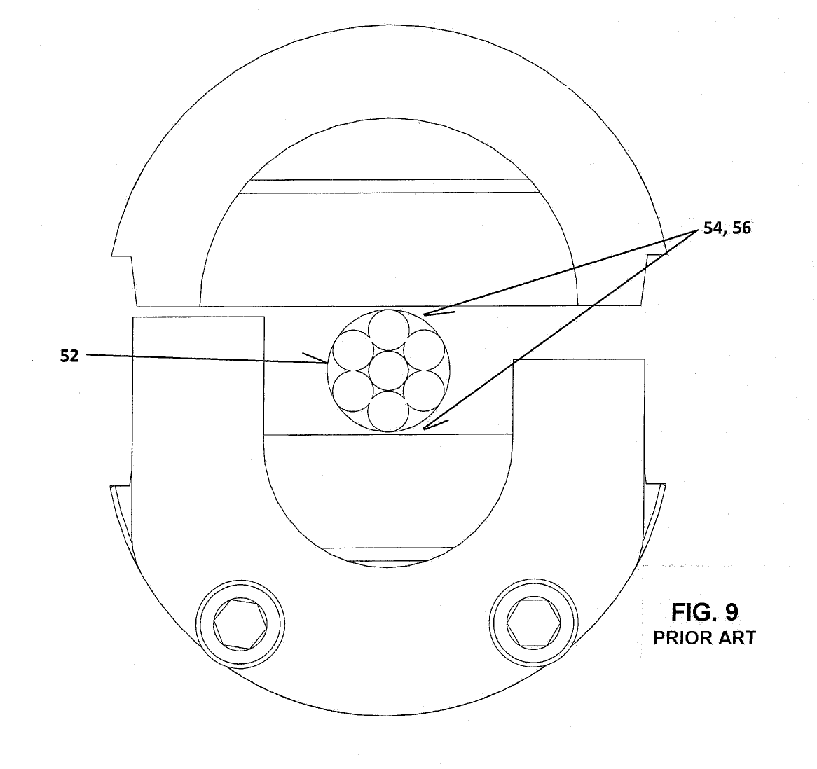

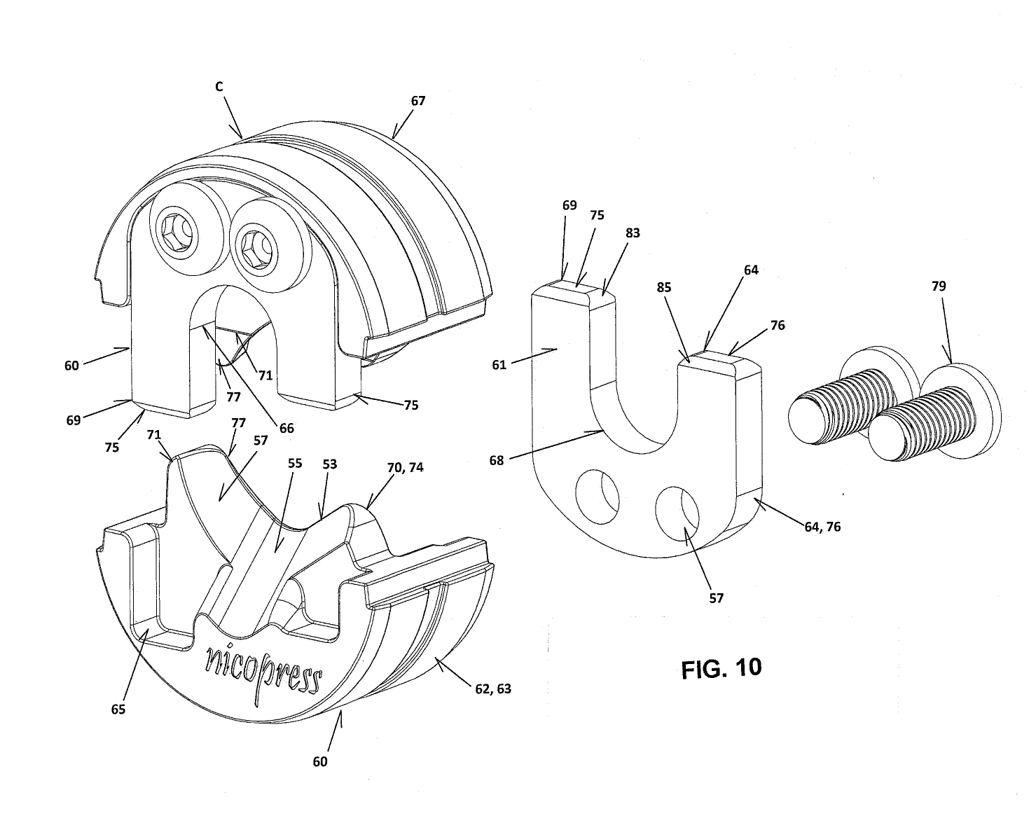

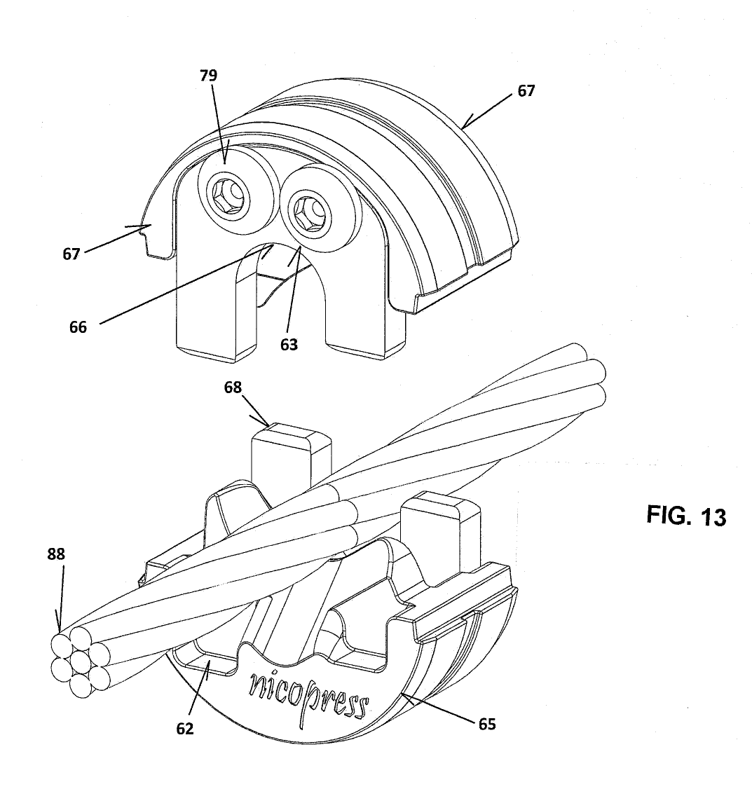

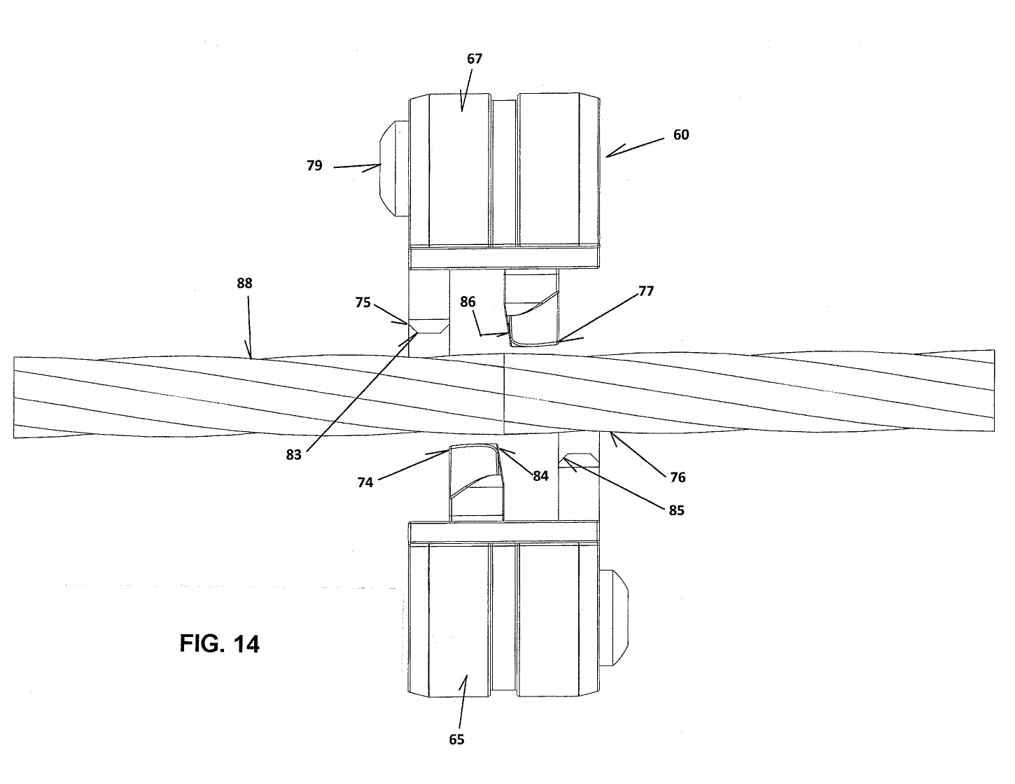

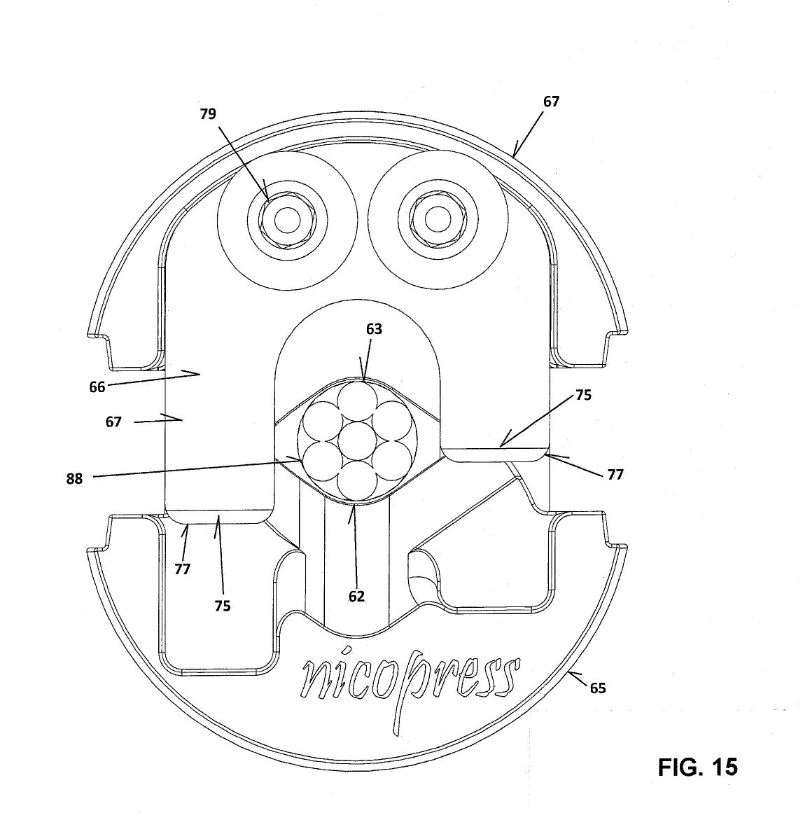

Referring now to FIGS. 10-15, a cutter C in accordance with another embodiment of the disclosure is shown. Cutter C has crossover cutting blades 62, 63, formed in bodies 65, 67, wire rope chamfer guides 64, 69 formed on metal plates 60, 61 and anti-rotation shelves 66, 68 formed in plates 60, 61. Shelves 66, 68 are formed in plates 60, 61 as U-shaped or curved grooves or notches. Specifically, the wire rope channels 66, 68 serve as anti-rotation shelves for the wire rope.

The cutting blades 62, 63 have cutting edges 70, 71 which are offset and tipped or canted at various pitches or angles to take advantage of the circular pressing action of the crimping or cutting tool and provide an improved, cleaner wire cut. Edges 70, 71 can have several portions or surfaces 53, 55, 57 which are at different planes and pitches to move easily to accommodate side insertion of the rope.

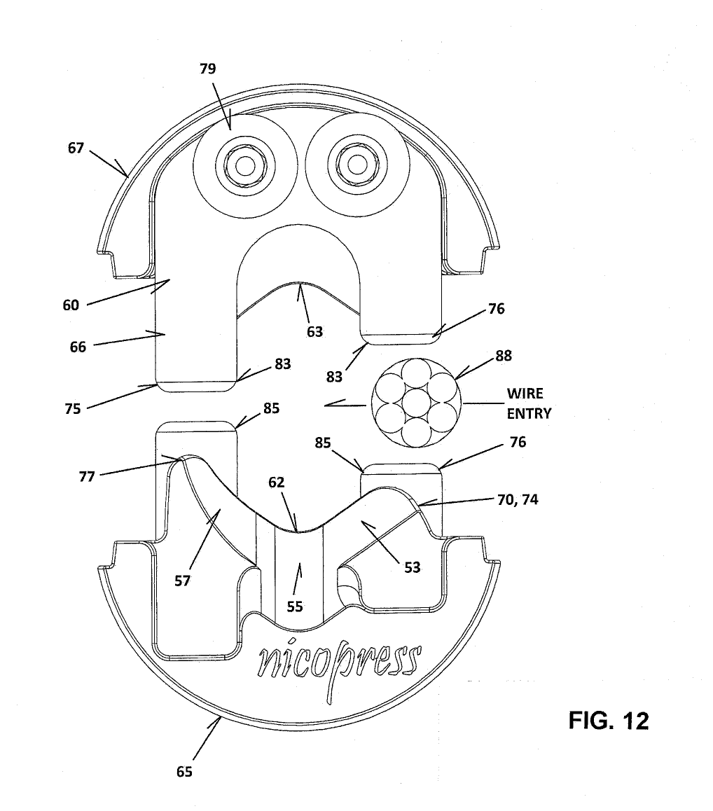

As seen in FIG. 10, cutting edge tips 74, 77 of edges 70, 70 and wire channel tips 75, 76 of channels 66, 68 are uneven or offset to facilitate sideways insertion of a wire rope 88 (FIG. 12) into the die. Also, cutting edge tips 74, 77 can have chamfered or tapered edges 84, 86 to facilitate alignment and guiding of the rope. Channel tips 75, 76 can also have chamfered edges 83, 85. Bolts or other fasteners 79 are used to secure the channels in holders 65, 67 via holes 57, 59. The rope 88 is preferably fully encapsulated by blades 62, 63.

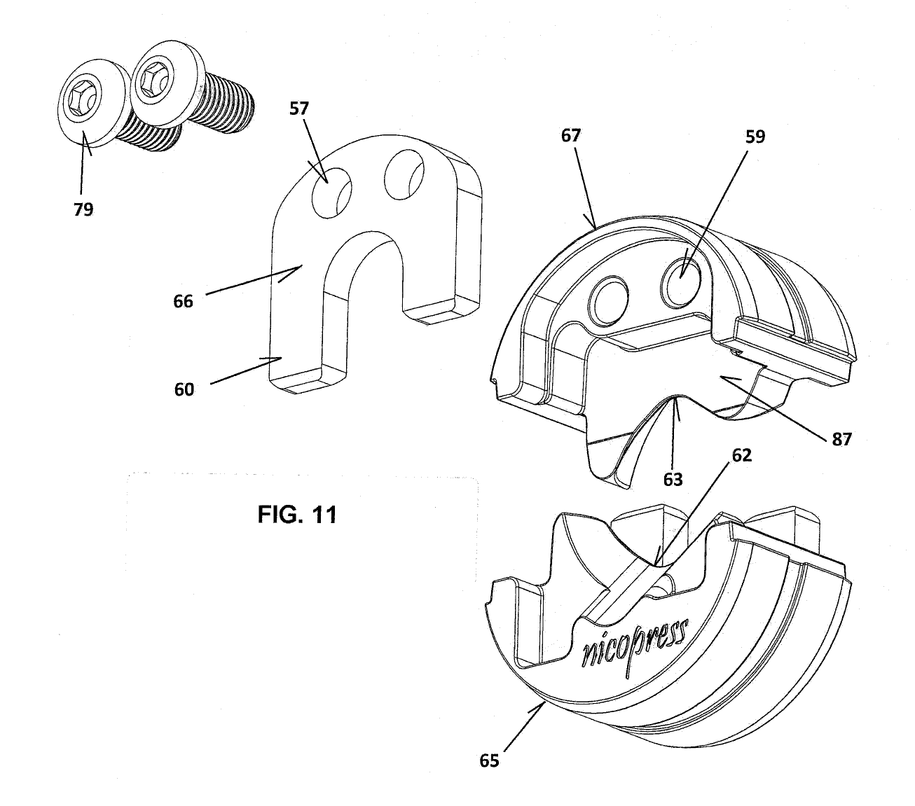

Referring to FIG. 11, the cutter die can be easily disassembled for ease of cleaning and for grinding or alignment. A cutter debris pocket 87 can be provided on body 80 for collecting debris from cutting.

The cutting dies are unique for the following reasons: a) a tipped or canted cutting edge which is approximately perpendicular to the circular path of the compression path; and b) a tipped or canted wire channel approximately tangent to the circular path of the tool compression jaw path.

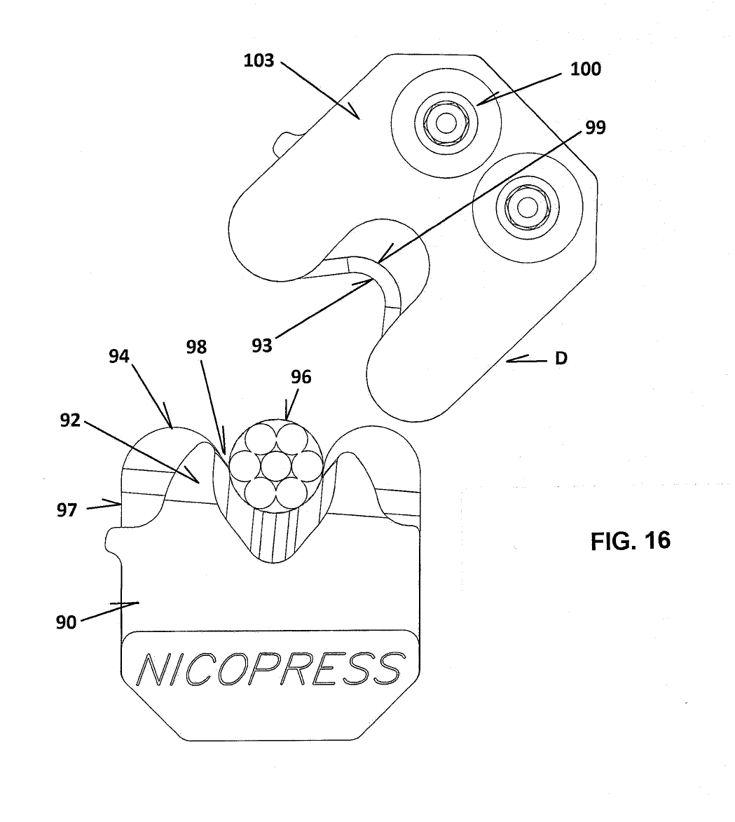

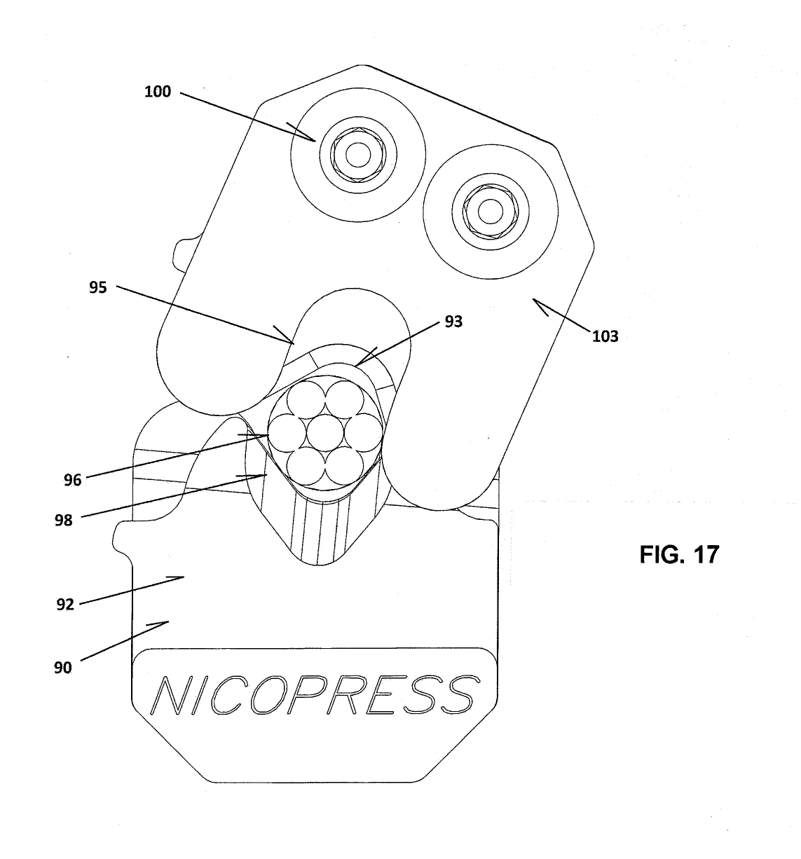

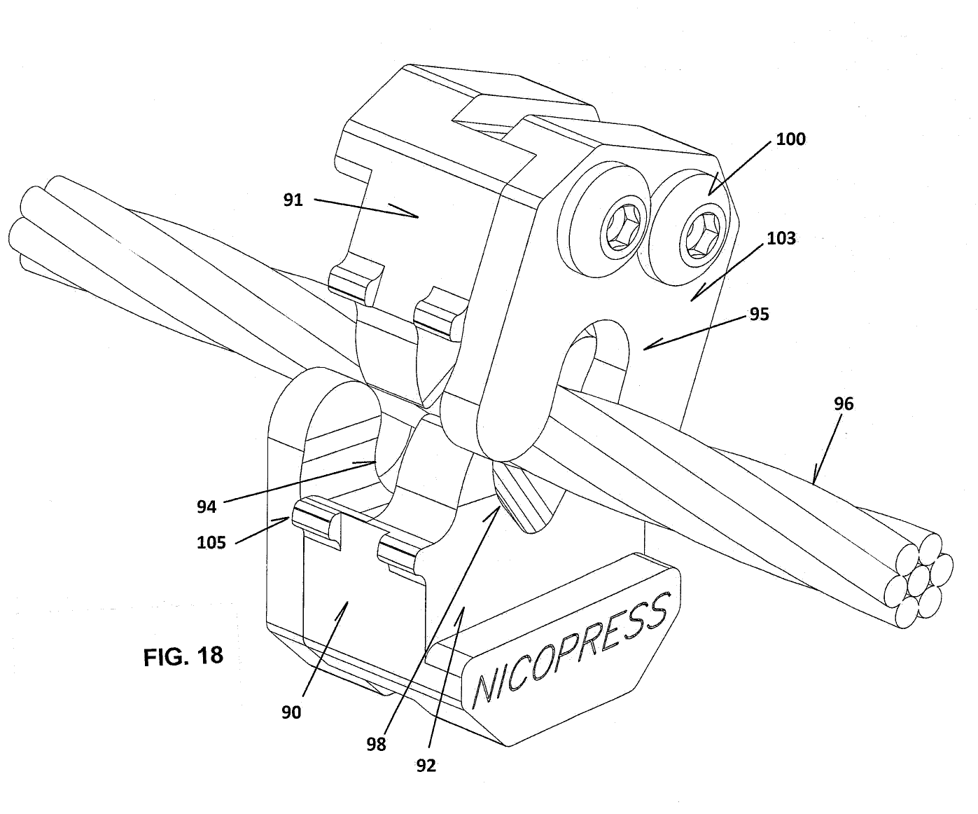

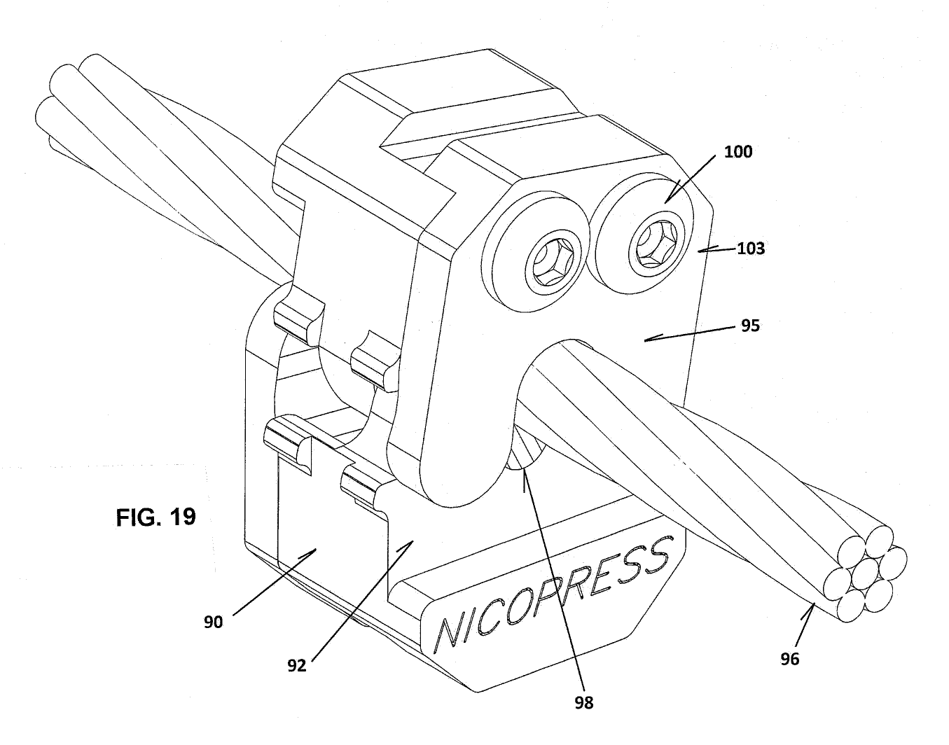

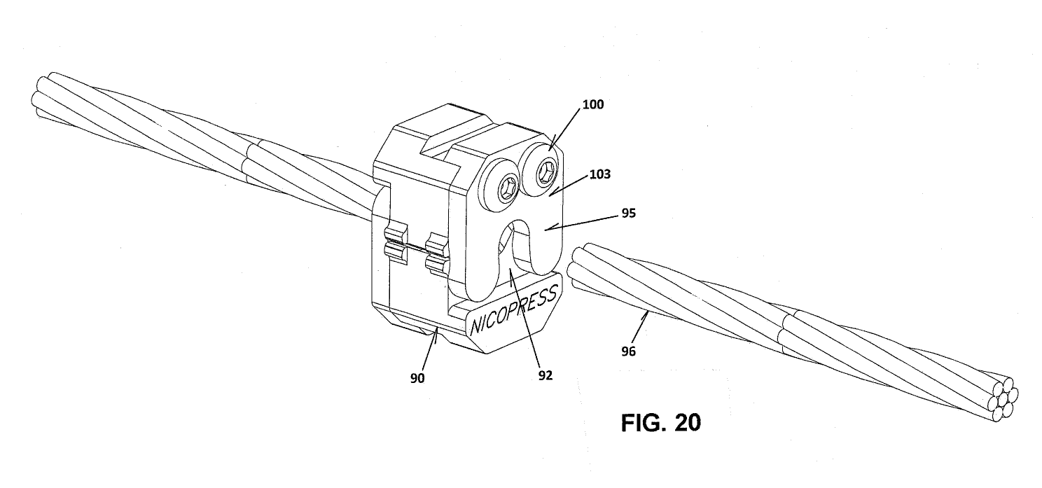

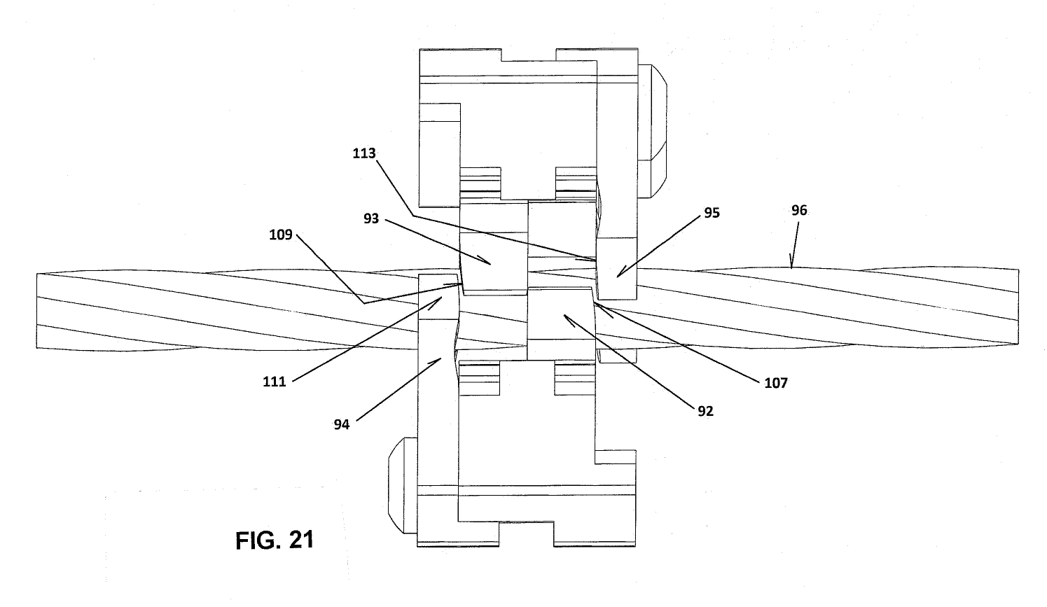

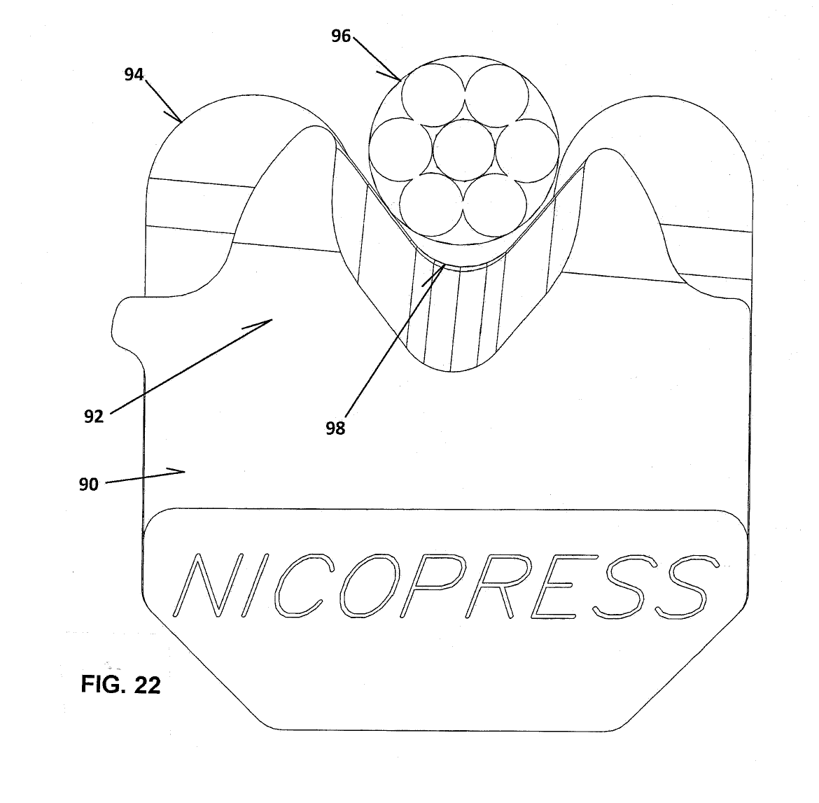

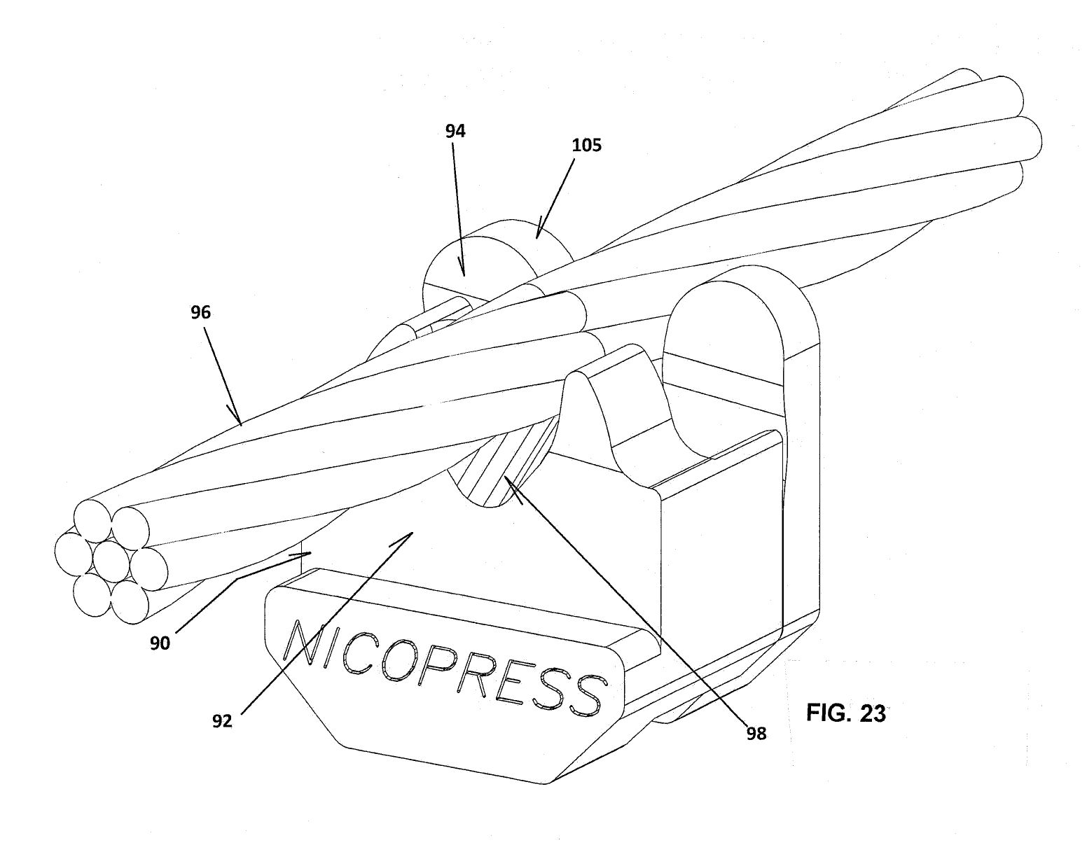

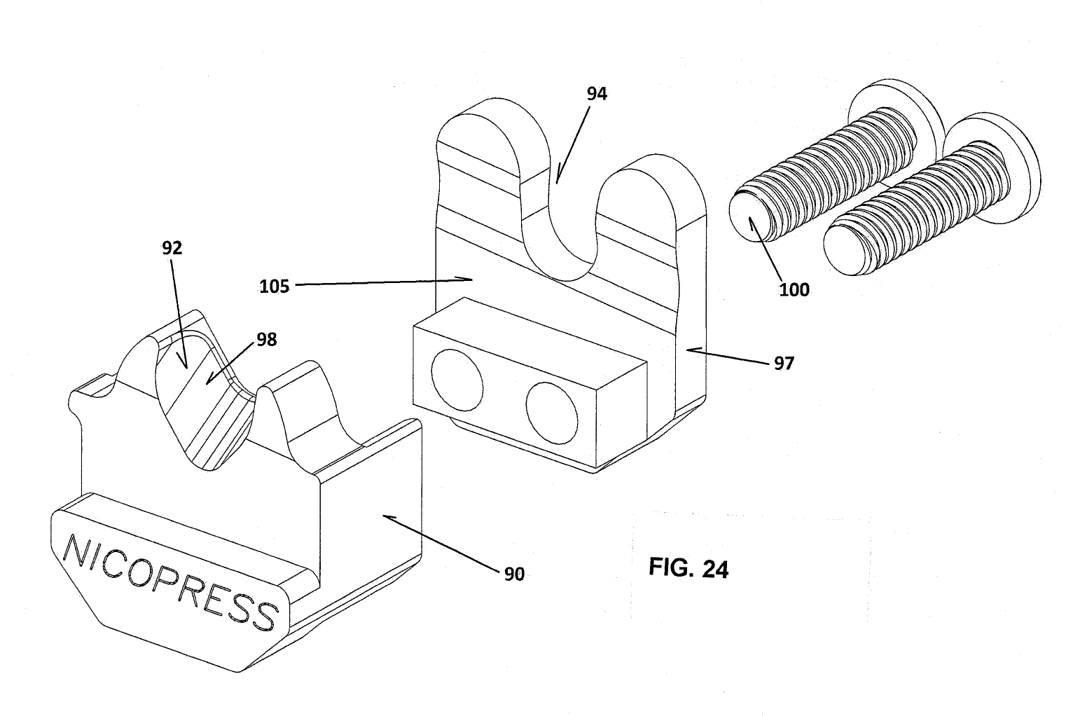

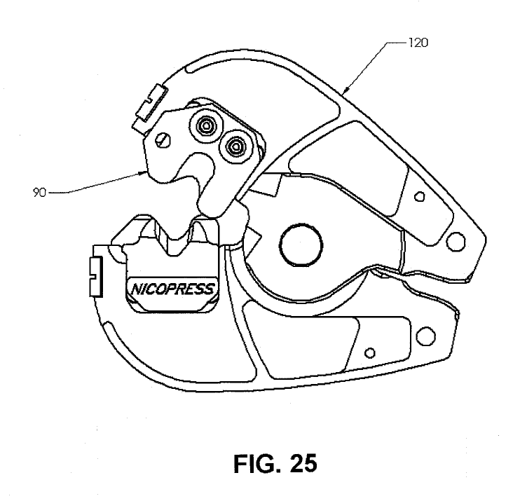

Referring now to FIGS. 16-25, a cutter die D in accordance with still another aspect of the disclosure is shown. The die D has lower and upper cutting blades 92, 93 with tapered or sloped or angled on canted edges 98, 99 formed in upper die and lower dies 90, 91 (FIG. 18) and canted or curved or sloped wire channels 94, 95 formed in bodies 103, 105 which take advantage of the circular pressing action of the cutting tool to provide an improved, cleaner wire cut. Blades 92, 93 can have tipped or beveled edges 107, 109 and channels 94, 95 can have tipped or beveled edges 111, 113 as shown in FIG. 21 to facilitate insertion of the rope and cutting. A wire rope 96 is fully encapsulated by both cutting edges 98, 99 of the blades and the wire channels 94, 95. Bolts 100 are used to secure the blades to channels through back plate 97 (FIG. 24). The back plate is removable for purposes of cleaning cutting dies including not having to remove them from the tool. FIGS. 16-17 show rotation of the upper blade 93 and channel 95 in bodies 91, 103 toward the lower blade 92 and channel 94 in bodies 90, 105 to perform the rope cutting. A fully cut rope 96 is shown in FIG. 20. The cutters D can be installed on a portable tool 120 as shown in FIG. 25.

Referring to FIG. 24, the cutter die can be easily disassembled for ease of cleaning and to facilitate fine grinding of the cutting edge surfaces for alignment and fit.

Advantages of the cutting dies are they include non-linear cutting blades for encapsulating and supporting the wire during cutting operations; and a separate wire channel for guiding and supporting the wire during the cutting operations. Another aspect of the disclosure is a curved ‘shelf’ at the bottom of the wire channel to support the wire and minimize or prevent the wire rope from rotating too much during the operation thereby causing an inferior cut.

Still another aspect of the disclosure is total encapsulation of the wire rope when working in conjunction with both the non-straight cutting edge and wire channel. Another aspect of the disclosure is a removable back or wire channel plate for purposes of cleaning cutting dies including not having to remove them from the tool.

An issue that may occur with some of the cutters is that they can jam after only a few cuts. A pocket formed in the cutting area can trap debris from the cutting process. The pocket in the cutting tool was the result of having extra material in the tool design to allow positive travel stops built into the cutter. The trapped debris would result in jamming of the tool.

In accordance with another aspect of the disclosure, to facilitate cutting debris evacuation, as much material as possible has been removed in the primary cutting area. This material removal effectively eliminated the integrated positive stops. The positive stops were then moved to the jaws of the hydraulic tool that fixtures the cutters.

Another aspect of the disclosure is the elimination of redundant bearing surfaces. Redundant bearing surfaces are the result of a tight fit between cutter halves and the jaws of the tool. The tight fit was loosened according to an aspect of the disclosure to allow play between the cutter halves and the tool jaws. The cutter halves are self aligning as they come together during the cutting process, thus, a tight fit would cause a jam. In other words, a redundant bearing. In this embodiment, the fit was loosened and more generous lead in angles were added to the mating surfaces to allow proper closure of the upper and lower cutting tools.

Other cutter tools had a pocket that was a debris trap which also did not allow the cutter body to be manufactured using standard machining and grinding practices. The pocket was removed to allow better debris evacuation and also allowed the part to be made with standard machining and grinding methods.

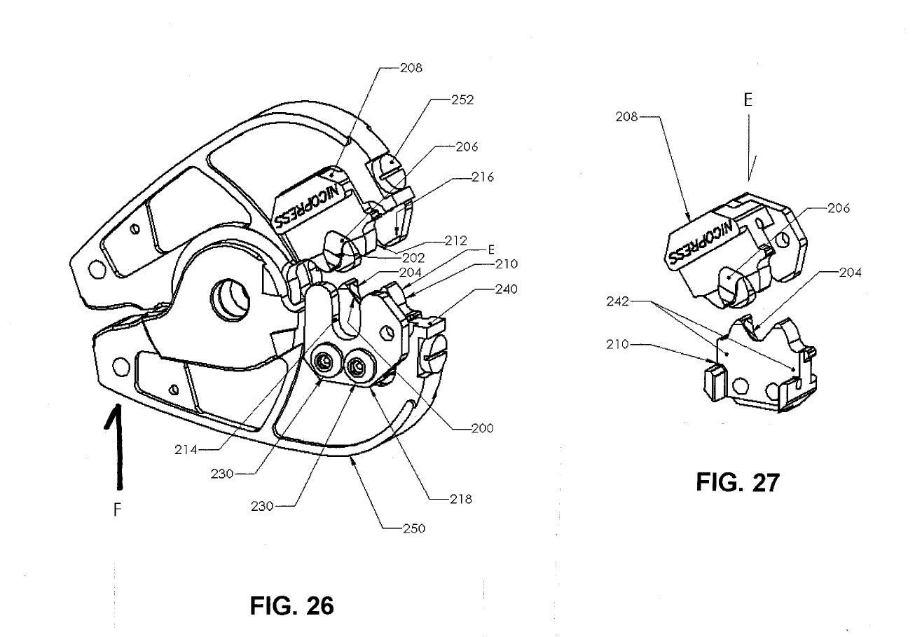

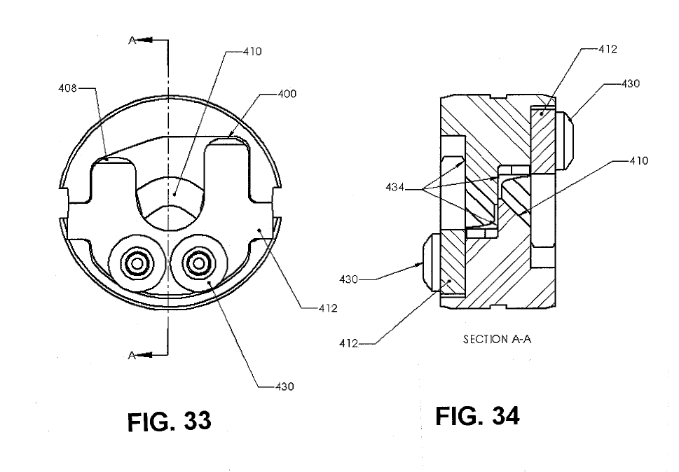

Referring now to FIGS. 26-34, a cutter die E in accordance with still another aspect of the disclosure is shown. The die E has lower and upper cutting blades 200, 202 with tapered or sloped or angled or canted cutting edges 204, 206 such as substantially V-shaped edges formed in upper die and lower dies 208, 210 and canted or curved or sloped wire channels 212, 214 formed in upper and lower bodies or retainers 216, 218 which take advantage of the circular pressing action of the cutting tool to provide an improved, cleaner wire cut.

Referring to FIG. 29, blades 200, 202 can have tipped or beveled edges 220, 222 and bodies 212, 214 can have generous lead angles 224, 226 (close to 90 degrees) to facilitate alignment of the cutters as the jaws rotate closed. A wire rope is fully encapsulated by both cutting edges of the blades and the wire channels. Bolts 230 are used to secure the blades to the retainers. The retainers are removable for purposes of cleaning cutting dies.

FIGS. 26-28 show rotation of the upper blade and channel in bodies toward the lower blade and channel in bodies to perform the rope cutting. The cutters E are installed on a portable tool F as shown in FIG. 26. The cutter die can be easily disassembled for ease of cleaning and to facilitate fine grinding of the cutter edge surfaces for alignment and fit.

FIG. 26 shows a cutting tool F in an open configuration with a cutter E mounted therein. Positive stops 240 have been added to the cutting tool body F and removed from the cutter E to facilitate remove material from the cutter body.

As seen FIG. 27, material was removed from the cutter body in area 242 to facilitate debris evacuation. FIG. 27 shows the retainer removed to show the material removed to facilitate debris evacuation. Removing material necessitated the removal of positive stops from cutter E.

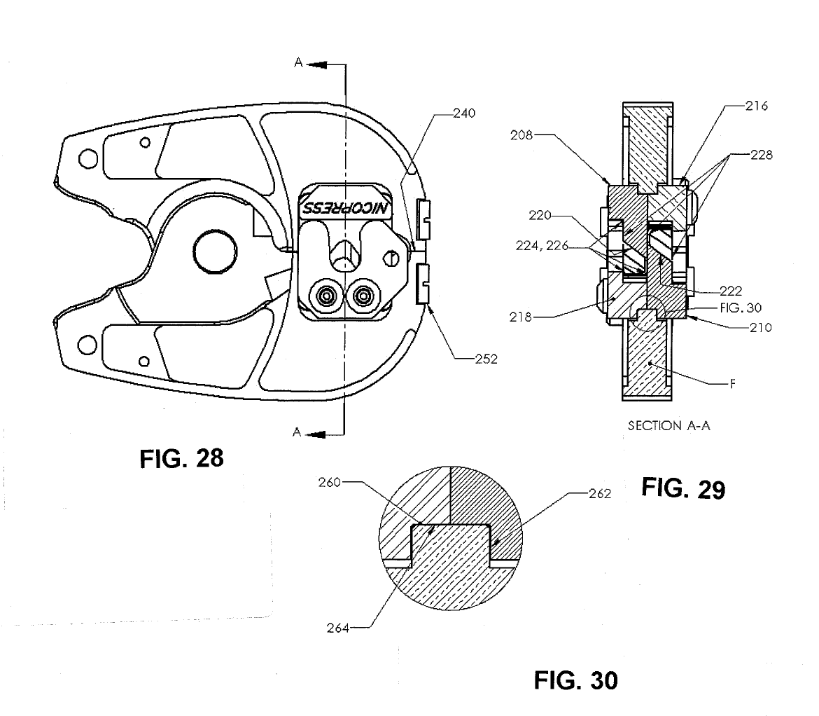

Referring to FIG. 28, the positive stops 240 were added to the jaws 250 of cutter tool F. Thumb screw retainers or fasteners 252 hold the cutter in place with the jaws in the open position.

As shown in FIG. 29, a precision sliding fit of the mating cutters and retainers is shown in areas 228. Generous lead angles 224, 226 facilitate alignment of the cutter as the jaws rotate closed.

Referring to FIG. 30, the cutters fit loosely into the jaw so that edges 260, 262, 264 of body 218, die 210 and tool F respectively loosely abut each other to avoid redundant bearing points or surfaces that would occur due to a tight fit between the cutter halves and the jaws and which would jam the tool during operation.

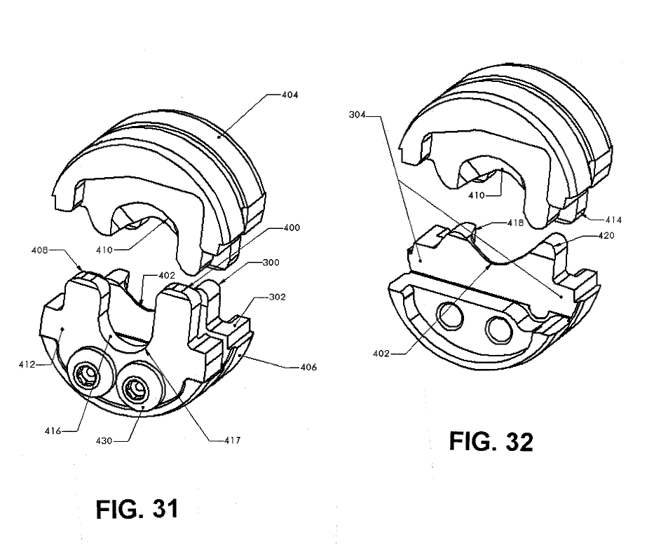

Referring now to FIGS. 31-34, a cutter body G in accordance with another aspect of the disclosure is shown. FIG. 31 shows a cutter body 300 which has a positive stop 302 formed integrally therein.

FIG. 32 shows the retainer removed to show area 304 where material was removed to facilitate debris evacuations and permit finish grind.

FIG. 34 shows the cutter in the closed configuration.

FIG. 34 shows lead angles which facilitate alignment of the cutters as the jaws close. A precision sliding fit is achieved on mating cutters and retainers.

Cutter G further has crossover cutting blades 400, 402, formed in bodies 404, 406, wire rope chamfer guides 408, 410 formed on metal retainers or plates 412, 414 and shelves or channels 416 formed in plates 412, 414. Shelves 417 are formed in retainer as U-shaped or curved grooves or notches. Specifically, the wire rope channels serve as the anti-rotation shelves 417 for the wire rope.

Referring to FIG. 32, the cutting blades have cutting edges 418, 420 which are offset and tipped or canted at various pitches or angles to take advantage of the circular pressing action of the crimping or cutting tool and provide an improved, cleaner wire cut. Edges 418, 420 can have several portions or surfaces which are at different planes and pitches to move easily to accommodate side insertion of the rope.

Cutting edge tips of edges 418, 420 and wire channel tips of guides 408, 410 can be uneven or offset to facilitate sideways insertion of a wire rope into the die. Also, cutting edge tips can have chamfered or tapered edges to facilitate alignment and guiding of the rope. Channel tips can also have chamfered edges. Bolts or other fasteners 430 are used to secure the retainers in cutting body via holes. Rope is preferably fully encapsulated by blades.

The cutter die can be easily disassembled for ease of cleaning and to facilitate fine grinding of the cutting edge surfaces for alignment and fit.

Advantages of the cutting dies are they include non-linear cutting blades for encapsulating and supporting the wire during cutting operations; and a separate wire channel for guiding and supporting the wire during the cutting operations. Another aspect of the disclosure is a curved ‘shelf’ at the bottom of the wire channel to support the wire and minimize or prevent the wire rope from rotating too much during the operation thereby causing an inferior cut.

Still another aspect of the disclosure is total encapsulation of the wire rope when working in conjunction with both the non-straight cutting edge and wire channel. Another aspect of the disclosure is a removable back or wire channel plate for purposes of cleaning cutting dies including not having to remove them from the tool.

The cutting dies are unique for the following reasons: a) a tipped or canted cutting edge which is approximately perpendicular to the circular path of the compression path; and b) a tipped or canted wire channel approximately tangent to the circular path of the tool compression jaw path.

Another aspect of the disclosure is removal of material from the cutter bodies to facilitate debris evacuation and allow finish grind, thus preventing jamming or damage of the cutter due to debris.

Another aspect of the disclosure is positive stops provided on the tool instead of the cutter body to facilitate removal of debris to improve operation of the tool.

Another aspect of the disclosure is a loosening of the fit between the cutter halves and the jaws to eliminate redundant bearing surfaces and jamming of the tool.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A cutter die, comprising:
a first body and a second body, said first body comprises a first cutter blade and said second body comprises a second cutter blade; wherein said first cutting blade and said second cutting blade encapsulate an associated wire rope;
a first blade holder for retaining said first body and a second blade holder for retaining said second body;
said first blade holder comprises an edge for supporting said wire rope, and said second blade holder comprises an edge for supporting said wire rope.

2. The cutter die of claim 1, wherein said first and second cutter blades each comprise substantially V-shaped grooves to encapsulate said wire rope.

3. The cutter die of claim 1, wherein said first cutting blade and said second cutting blade are symmetrical to each other.

4. The cutter die of claim 1, wherein said first cutting blade and said second cutting blade are formed in metal plates.

5. The cutter die of claim 1, wherein said first blade holder comprises a pair of side walls and a wall extending therebetween forming a channel in said first blade holder.

6. The cutter die of claim 1, wherein said second blade holder comprises a pair of side walls and a wall extending therebetween forming a channel in said second blade holder.

7. The cutter die of claim 1, wherein said first blade holder comprises a substantially U-shaped groove forming said edge for supporting said wire rope and minimizing rotation of said rope during cutting.

8. The cutter die of claim 1, wherein said second blade holder comprises a substantially U-shaped groove forming said edge for supporting said wire rope and minimizing rotation of said rope during cutting.

9. The cutter die of claim 1, wherein said first cutting blade is secured to said first blade holder via fasteners.

10. The cutter die of claim 1, wherein said second cutting blade is secured to said second blade holder via fasteners.

11. A cutter die comprising:
a first body having a first cutting blade and a second body having a second cutting blade;
a third body having a groove formed therein;
and a fourth body having a groove formed therein;
wherein said third body further comprises chamfered ends on opposite sides of said groove of said third body and said fourth body comprises chamfered ends formed on opposite sides of said groove of said fourth body,
wherein said first cutting blade and said second cutting blade each comprise a cutting edge which is cantered and offset.

12. The cutter die of claim 11, wherein said chamfered ends of said third body and said chamfered ends of said fourth body are offset.

13. The cutter die of claim 11, wherein said cutting edges of said first and second cutting blade are each chamfered.

14. The cutter die of claim 13, wherein said cutting edges of said first and second cutting blades have two or more portions which are oriented in different planes to facilitate side insertion of a wire rope.

15. The cutter die of claim 11, wherein said third and fourth bodies are retained in said first and second bodies by fasteners.

16. A cutter tool comprising:
a first cutting blade and a first retainer;
a second cutting blade and a second retainer; and
a cutting jaw assembly wherein said first and second cutting blades and said first and second retainers are secured to first and second jaws of said jaw assembly wherein positive stops are formed on said first and second jaws.

17. The cutter die of claim 16, wherein said first and second cutter blades each comprise substantially V-shaped grooves to encapsulate wire rope.

18. The cutter die of claim 16, wherein said first retainer and second retainer each comprises a substantially U-shaped groove forming an edge for supporting wire rope and minimizing rotation of said rope during cutting.

19. The cutter die of claim 16, wherein said first cutting blade is secured to said first retainer via fasteners and said second cutting blade is secured to said second retainer via fasteners.

20. The cutter tool of claim 16, wherein said first and second retainers comprise lead angles to facilitate alignment of said first and second cutting blades as said first and second jaws close.
